(19) United States
(12) Patent Application Publication
(10) Pub. No.: US 2006/0188689 A1
(43) Pub. Date: Aug. 24, 2006

(54) Dust control mat

(76) Inventor: Terence M. Hedley, Bedfordshire (GB)

Correspondence Address: MILLIKEN & COMPANY, PO BOX 1926, SPARTANBURG, SC, 29303, US

(21) Appl. No.: 10/551,410

(22) PCT Filed: Mar. 26, 2004
(86) PCT No.: PCT/GB04/01316

§ 371 Date: Sep. 29, 2005

(30) Foreign Application Priority Data
Apr. 4, 2003 (GB) 0307828.4

(51) Int. Cl. B32B 33/00; B32B 3/02

(52) U.S. Cl. 428/86; 428/95

(57) ABSTRACT

A washable floor mat has a textile layer (1) and a backing layer (2). The textile layer (1) includes a spacer fabric having a first fabric layer (3), a second fabric layer (4) and an intermediate pile layer (5) that interconnects and spaces the first and second fabric layers.

The present invention relates to a dust control mat, and in particular to one having a high dust capacity. The invention also relates to a method of making such a mat.

Dust control mats are usually placed at the entrances to shops, offices and factories to remove dust and moisture from the feet of pedestrians entering the building. By the term “dust” we mean all kinds of solid particulate dirt, including sand, grit and other contaminants.

A common dust control mat comprises a tufted pile textile top surface having good moisture and dirt absorbing properties, which is bonded to a backing layer of vulcanised rubber. Various different textile materials are available, including synthetic materials such as high twist nylon and natural fibres such as cotton. These textiles have different performance characteristics. For example, nylon mats have very good dust control properties and are hard wearing, but they do not have very good moisture absorbing properties. Cotton mats on the other hand have very good moisture absorbing properties, but have inferior dust control properties and tend to be less durable than nylon mats. Both types of mat have only a limited dust capacity (i.e. they are capable of absorbing only a limited quantity of dust) and they must therefore be cleaned regularly.

Dust control mats of the type described above are generally washable by immersion and agitation in water. Many such mats are used in the industrial and rental market sectors. Those mats tend to be owned by a laundry, which rents the mats to its clients and regularly replaces soiled mats with clean mats and returns the soiled mats to the laundry for cleaning. Some mats of the same type are also used in the commercial and retail sectors, in which case they are generally owned by the end user. Often, those mats are not regularly washed, as the owner does not usually have suitable washing facilities.

When a dust control mat is used in a very dusty or dirty environment, it can quickly become heavily contaminated with dust, thereby reducing its effectiveness and adversely affecting its appearance. For mats used in the industrial and rental market sectors this leads to high laundry costs, whereas for mats used in the commercial and retail sectors, thorough cleaning may rarely or never take place. There is a need therefore for a mat with a high dust capacity, which is relatively easy to clean.

Dust control mats sometimes carry a logo or image. A simple logo can be created by forming the textile surface from a mosaic of tufted materials of different colours. Alternatively, a more complicated pattern or image can be applied to the mat by printing the textile surface. However, because the tufted pile can move during and after printing, the observable resolution of the printed image is very low. In practice, the maximum observable resolution that can be achieved is no higher than about 20 dpi (dots per inch). The images that can be printed on the mats are therefore limited to relatively simple patterns and logos.

It is known to produce a floor mat with a surface that can carry a higher resolution image, such as a photographic image or an advertising message. Such mats are sometimes called poster mats or advertising mats. These mats generally have a textile surface with either no pile or only a very short pile, since a longer pile is not capable of supporting an image with a high observable resolution. As a result, they generally have poor dust control properties. There is also a need therefore for a mat that is capable of supporting a high resolution image (e.g. with an observable resolution of 75 dpi or higher) and that has good dust control properties.

It is also known to provide a highly resilient anti-fatigue mat, for use by workers who have to spend prolonged periods standing in one position. Such mats generally incorporate foam rubber to provide the necessary resilience. An example is described in WO01/74206.

According to the present invention there is provided a dust control mat having a textile layer and a backing layer, wherein the textile layer includes a spacer fabric having a first fabric layer that forms the upper surface of the mat, a second fabric layer that forms the lower surface of the textile layer and an intermediate pile layer that interconnects and spaces the first and second fabric layers.

A spacer fabric is a three dimensional fabric, typically having a thickness of 2 to 20 mm, which comprises two plain ground fabric layers and an intermediate pile layer that interconnects and spaces the two ground fabric layers. Spacer fabrics can be made by warp knitting on a double needlebar Rachel machine. The intermediate pile layer consists of a resilient pile yarn, usually a synthetic monofilament fibre, that extends between the ground fabric layers substantially perpendicular to the faces of the fabric. The intermediate pile layer maintains a substantially uniform separation between the ground fabric layers but is resilient, allowing the spacer fabric to be compressed. Many types of spacer fabric are known, some examples being described in U.S. Pat. No. 5,385,036, US2001/11442, U.S. Pat. No. 5,817,391, U.S. Pat. No. 6,037,035 and U.S. Pat. No. 5,896,758.

We have found that a spacer fabric provides a highly effective dust control textile, having good dust removal properties and a very large dust capacity. A dust control mat that incorporates a spacer fabric is therefore particularly suitable for use in very dusty environments. The mat can also be cleaned very easily, using a dry mechanical cleaning process (for example, beating, vacuum cleaning or dry tumbling). Further, if washing is required, we have found that the mat drains very well and it can thus be dried with minimal or no tumbling. Cleaning costs are therefore very low.

The mat is also suitable for printing and is capable of carrying a high resolution printed image, owing to the flat and substantially pileless surface of the spacer fabric. It is therefore possible to provide a poster mat that has good dust control properties.

The mat is also highly resilient, providing good anti-fatigue properties, and it is therefore suitable for use by workers who have to stand for prolonged periods in one position.

Advantageously, the first fabric layer comprises a mesh having a number of openings through which dust and dirt can fall into the interior of the textile layer. The openings may have a width of 0.5-10 mm, preferably 1-4 mm, more preferably 2-3 mm. The term “width” as used herein refers to the diameter of a sphere that will pass through the opening. Advantageously, the first fabric layer is a knitted fabric of approximately gauge 11.

The first fabric layer may be made for example of a multifilament yarn, preferably polyester yarn, which provides a very good printing surface, or any other suitable yarn.

Advantageously, the first fabric layer is made of a yarn having a decitex of 100-200, preferably 136-167, more preferably approximately 150.

The second fabric layer preferably has a substantially closed structure with denser construction than the first fabric layer, to prevent rubber or adhesive from entering the spacer fabric when bonding the textile layer to the backing layer. Advantageously, the second fabric layer is a knitted fabric of approximately gauge 22 or higher.

Advantageously, the second fabric layer is made of a multifilament yarn, preferably polyester yarn. Advantageously, the second fabric layer is made of a yarn having a decitex of 100-200, preferably 136-167, more preferably approximately 150.

The intermediate pile layer may have a thickness of 2-10 mm, preferably approximately 4-6 mm, to provide a good dust capacity and an appropriate degree of resilience.

Advantageously, the intermediate pile layer is made from a monofilament yarn having a diameter in the range 0.04-3 mm, preferably 0.05-0.3 mm, more preferably 0.1-0.2 mm. We have found that this provides an appropriate degree of resilience for a floor mat.

Advantageously, the intermediate pile layer is made from a synthetic monofilament yarn, preferably a polyester yarn.

The textile layer may be a warp knit fabric, preferably a Raschel knit fabric.

Advantageously, the backing layer is bonded to the second fabric layer The backing layer may be made of rubber, preferably nitrile rubber. This provides very good stability and resists slipping, creep and curling of the mat. The thickness of the rubber backing layer may be from 0.5 mm to 5 mm, preferably 0.8 mm to 3 mm. The rubber backing layer may be vulcanised to the second fabric layer.

The textile layer may be printed, preferably with sublimatic inks. We have found that a high resolution image may be transferred to the mat using this process. Advantageously, the textile layer is printed with an image having an observable resolution of at least 75 dpi. Generally, the textile layer has an area of at least 0.2 m² (e.g. 40 cm×50 cm) and preferably at least 1 m² or larger.

According to a further aspect of the invention there is provided a method of manufacturing a dust control mat, the method including the steps of bonding a backing layer to a textile layer that includes a spacer fabric having a first fabric layer, a second fabric layer and an intermediate pile layer that interconnects and spaces the first and second fabric layers.

The spacer fabric may be a knitted fabric, preferably a warp knitted fabric, more preferably a Rachel knit fabric. Advantageously, the first fabric layer comprises a mesh having a number of openings, and the second fabric layer has a substantially closed structure.

The backing layer of rubber is preferably vulcanised to the textile layer in a heated press.

The textile layer is advantageously printed using a sublimatic printing process, preferably during the backing process.

According to a further aspect of the invention there is provided a dust control mat having a textile layer that includes a spacer fabric having a first fabric layer that forms the upper surface of the mat, a second fabric layer that forms the lower surface of the textile layer and an intermediate pile layer that interconnects and spaces the first and second fabric layers. Advantageously, the first fabric layer comprises a mesh having a number of openings through which dust and dirt can fall into the interior of the textile layer.

Embodiments of the invention will now be described, by way of example, with reference to the accompanying drawings, in which:

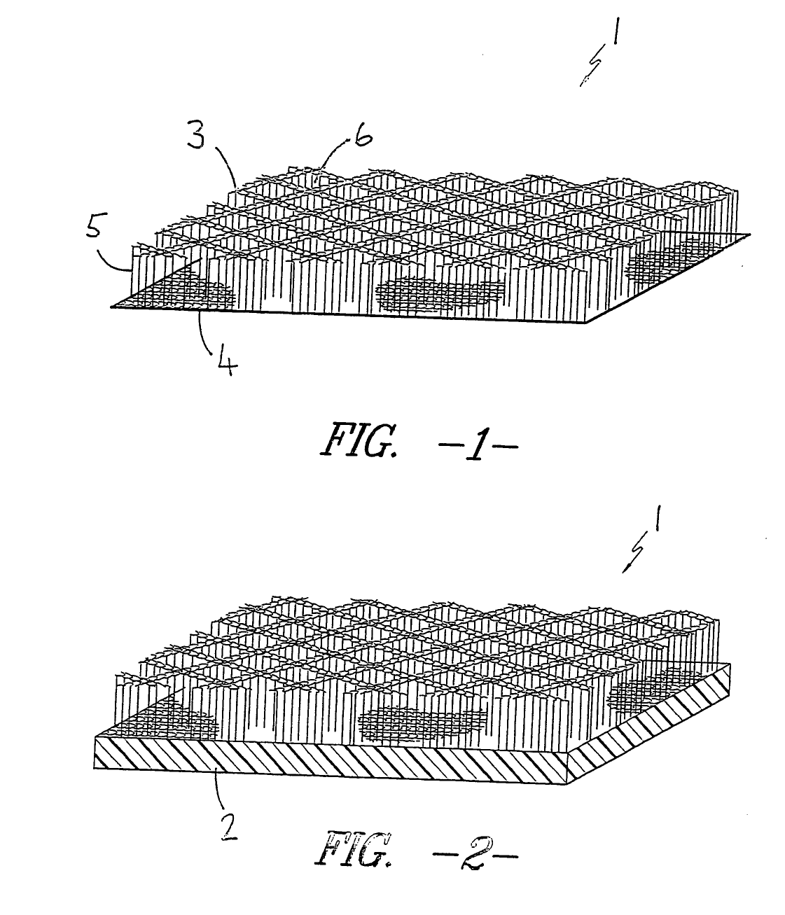

FIG. 1 is an isometric view of a spacer fabric;

FIG. 2 is an isometric view of a mat according to the invention, and

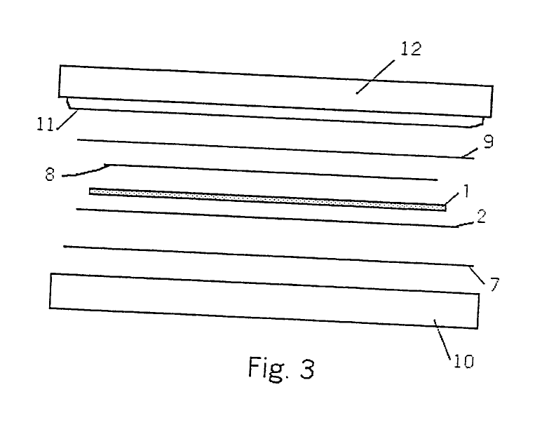

FIG. 3 is a side elevation of a mat assembly laid up in a heated press.

The mat shown in FIG. 2 includes an upper textile layer 1, which is bonded to a lower backing layer 2, for example of vulcanised nitrile rubber. Optionally, the backing layer may be slightly larger than the textile layer, to provide a rubber border (not shown). The overall size of the mat is typically 85 cm×150 cm.

The textile layer 1, which is shown separately in FIG. 1, comprises a three-dimensional spacer fabric. Such fabrics are well known, some examples being described for instance in U.S. Pat. No. 5,385,036, WO96/32526, U.S. Pat. No. 5,817,391 and US2001/0011442, the entire contents of which are incorporated by reference herein.

The textile layer 1 is constructed by knitting a three dimensional spacer fabric using a double needlebar warp knitting machine, for example of the Raschel type. This produces a double faced spacer fabric comprising a first fabric layer 3 that in use forms the upper surface of the mat, a second fabric layer 4 that forms the lower surface of the textile layer and is bonded to the backing layer 2, and an intermediate pile layer 5 comprising a resilient pile yarn that interconnects and spaces the first and second fabric layers 3,4 from one another. The intermediate layer 5 is resilient, allowing some compression of the textile layer 1, but restoring the separation of the first and second fabric layers 3,4 when the deforming force is removed.

The first fabric layer 3 preferably has an open mesh or net-like structure, with a plurality of openings 6 that allow dust to fall through the layer into the space between the first and second layers. The openings 6 may for example be roughly square in shape or they may be roughly hexagonal or circular, with a width in the range 0.5-10 mm, typically 1-4 mm and preferably 2-3 mm. The upper surface of the first fabric layer 3 is relatively smooth and very stable, allowing it to support a printed image with a high observable resolution. The first fabric layer may for example consist of a Raschel warp knit fabric, made using course and gauge settings to provide a relatively open structure. For example, the construction of the first fabric layer 3 may be 6 course Atlas at 11 gauge, made of 150 decitex polyester multifilament yarn.

The second fabric layer 4 preferably has a dense and substantially closed structure, to provide a coherent foundation that is suitable for bonding to the backing layer 2. There should not be any significant openings in the fabric layer, to avoid any significant ingress of rubber, glue or other bonding substances into the textile layer during the backing process. For example, the construction of the second fabric layer 4 may be 2 bar, full set 22 gauge, tricot stitch, made of 150 decitex polyester multifilament yarn.

The intermediate pile layer 5 may be made of a monofilament yarn, a multifilament yarn or a combination of monofilament and multifilament yarns. Preferably, it is made of polyester or nylon monofilaments having a diameter of 0.1-0.2 mm. For example, the construction of the intermediate pile layer may typically be half set 22 gauge, single bar, 5 needle V, using 0.15 mm monofilament. The thickness of the intermediate layer 5 is generally 2-10 mm, typically 4-6 mm. The intermediate layer 5 has a relatively open structure, to provide a large dust capacity.

The backing layer 2 is made of any suitable material that provides the mat with the necessary stability: i.e. which prevents slipping and excessive creep as the mat is walked on, and causes the mat to lie flat on the floor. Preferably, the backing layer is made of a nitrile rubber, having a thickness of 0.5-5 mm, preferably 0.8-3 mm. The backing layer may be made of solid or foam rubber, or from a sheet of bonded rubber granules. Alternatively, it can be made of any other suitable material, such as PVC or latex.

The mat is manufactured by bonding the textile layer 1 to the backing layer 2. If the backing sheet is made of rubber, the mat can be manufactured by vulcanising a sheet of unvulcanised rubber to the textile layer in a heated press. In the method shown in FIG. 3, a mat assembly comprising a textile layer 1 and a sheet of unvulcanised rubber for the backing layer 2 is laid up on a bottom release sheet 7, made for example of PTFE-coated woven glass. A print transfer sheet 8 that has been printed with an image using sublimatic dyes may optionally be placed face down on top of the textile layer 1. A top release sheet 9 is placed on top of the mat assembly, which is then placed in a press that includes a heated metal platen 10 and an inflatable diaphragm 11 secured to an upper plate 12.

The laid-up mat assembly is pressed in the heated press, for example at a temperature of 170° C. and a pressure of 30 pounds per square inch, applied for a cycle time of up to twenty minutes. The heat from the press softens and vulcanises the rubber, bonding it to the lower surface of the textile layer 1. At the same time, if a print transfer sheet is used, the heat vaporises the sublimatic dyes, transferring the printed image onto the upper surface of the textile layer.

Once this process has been completed, the mat is removed from the press, the release sheets 7,9 are removed and, if necessary, the edges of the backing layer are trimmed. Optionally, the backing layer 2 may be perforated, to allow the passage of water during a spin drying process.

Alternative manufacturing methods include bonding the textile layer to a backing layer, for example of granulated rubber or PVC, using an adhesive, and coating the lower face of the textile with a suitable backing material such as latex.

We have found that a dust control mat according to the present invention, with a textile layer made of a spacer fabric, provides an audible scraping effect that encourages people to wipe their feet, and is highly efficient at removing dust from the feet of pedestrians. The dust falls through the openings in the first fabric layer and is held between the filaments of the intermediate pile layer.

We have also found that the mat has a much higher dust capacity than a conventional tufted nylon dust control mat. For example, in one test, we compared the absorbency of the new mat with that of a conventional tufted nylon dust control mat by filling 100 cm² samples with sand and then weighing the samples, to determine the dust capacity of the mat. The results were as follows:

Regular tufted nylon cut pile mat: 4.17 kg/m²

Spacer fabric on rubber backing: 8.13 kg/m²

It therefore appears from this test that dust capacity of the new mat is approximately double that of the conventional tufted dust control mat.

Further, we have found that the mat is relatively easy to clean. The majority of the dust retained by the mat can be removed simply by beating, shaking or dry tumbling the mat, or by cleaning it with a vacuum cleaner. If necessary, the surface appearance can then be restored, either by washing or by applying a surface cleaner. If the mat is washed, we have found that it dries very quickly and easily, thereby possibly avoiding the need for tumble drying or at least greatly reducing the energy required to dry the mat.

We have also found that the upper surface of the first fabric layer is capable of supporting an image with a high observable resolution, since the upper layer of the spacer fabric is stable and smooth, with virtually no pile.

Various modification of the invention are of course possible, some of which will now be described.

Numerous different kinds of spacer fabric may be used, employing different yarns. The intermediate pile layer may for example be made of a number of synthetic monofilament yarns, including polypropylene, polyethylene, polyester and polyamide yarns. The thickness of the monofilament will depend on the required thickness of the mat: for example a yarn with a thickness of 0.05-0.11 mm might be used for a fabric with a thickness of 4-5 mm. The monofilament yarns may be all the same material and thickness or, in some circumstances, yarns of different materials and thickness may be used. Alternatively, a multifilament yarn or a combination of monofilament and multifilament yarns may be used. At least some of the yarns making up the intermediate layer may be bowed, to increase the resilience of the textile.

For the first and second outer layers of the spacer fabric, multifilament yarns will generally be used. These may be spun yarns or composite yarns such as core spun yarns, plied yarns or technical yarns. Various natural and synthetic materials may be used including, for example, jute, cotton, polyester and glass. These yarns do not have to be all the same type: a mixture of materials and diameters can be used to provide different characteristics. Further, the yarns of the first and second layers and the intermediate layer may be all the same, or all different.

The yarns may be white, allowing the mat to be printed or dyed, or coloured yarns may be used to produce a single or multi-colour mat. If a printed mat is required, the textile may be printed before, during or after bonding to the backing layer, by any of a variety of suitable printing processes.

A substrate layer, for example of woven or non-woven polyester, may be provided between the textile layer and the backing layer. The edges of the textile layer may optionally be sealed. The mat may have rubber borders or printed “optical” borders, or it may be borderless. The mat may include one or more areas of another fabric, for example a tufted pile fabric or a knitted, woven or non-woven fabric. The upper surface of the textile surface may be sanded, brushed or napped to modify its appearance, feel and dust/moisture control properties. The textile layer may be treated with a hydrophilic agent or a soil release agent.

The backing layer may be made of solid or foam rubber, granulated rubber, PVC, latex or any other suitable material. Alternatively, the backing layer may be omitted and the mat secured in position by some other means, for example by attaching it to the floor or a supporting frame, or using coated fibres for the lower fabric layer.

1-31. (canceled)

32. A dust control mat having a textile layer and a backing layer, wherein the backing layer is made of rubber, and wherein the textile layer comprises a spacer fabric having (a) a first fabric layer that forms the upper surface of the mat, said first fabric layer comprising a mesh having a number of openings, (b) a second fabric layer that forms the lower surface of the textile layer, said second fabric layer having a substantially closed structure and being bonded to the rubber backing layer, and (c) an intermediate pile layer that interconnects and spaces said first and second fabric layers.

33. The dust control mat according to claim 32, in which the openings of the mesh of said first fabric layer have a width of between 0.5 mm and 10 mm.

34. The dust control mat according to claim 33, in which the openings of the mesh of said first fabric layer have a width of between 1 mm and 4 mm.

35. The dust control mat according to claim 34, in which the openings of the mesh of said first fabric layer have a width of between 2 mm and 3 mm.

36. The dust control mat according to claim 32, in which the first fabric layer is a knitted fabric of approximately gauge 11.

37. The dust control mat according to claim 32, in which the second fabric layer is a knitted fabric of approximately gauge 22 or higher.

38. The dust control mat according to claim 32, in which the first fabric layer and the second fabric layer are made of multifilament polyester yarns.

39. The dust control mat according to claim 38, in which the first fabric layer and the second fabric layer are made of a yarn having a decitex in the range of from 100 to 200.

40. The dust control mat according to claim 32, in which the intermediate pile layer has a thickness of from 2 mm to 10 mm.

41. The dust control mat according to claim 32, in which the intermediate pile layer is made from monofilament yarns having a diameter in the range of from 0.04 mm to 3 mm.

42. The dust control mat according to claim 41, in which the intermediate pile layer is made from polyester monofilament yarns.

43. The dust control mat according to claim 32, wherein the backing layer is made of nitrile rubber.

44. The dust control mat according to claim 43, wherein the thickness of the rubber backing layer is from 0.5 mm to 5 mm.

45. The dust control mat according to claim 32, in which the rubber backing layer is vulcanised to the second fabric layer.

46. The dust control mat according to claim 32, wherein the textile layer is printed.

47. The dust control mat according to claim 46, in which the textile layer is printed with an image having an observable resolution of at least 75 dpi.

48. The dust control mat according to claim 32, wherein the textile layer has an area of at least 1 m².

49. A method of manufacturing a dust control mat, the method including the steps of (a) providing a textile layer, the textile layer comprising a spacer fabric having a first fabric layer comprising a mesh having a number of openings, a second fabric layer having a substantially closed structure, and an intermediate pile layer that interconnects and spaces said first fabric layer and said second fabric layer; (b) providing a backing layer made of rubber; and (c) bonding the backing layer to the second fabric layer by vulcanization in a heated press, such that the first fabric layer becomes the face of said dust control mat.

50. The method according to claim 49, in which the spacer fabric is a Raschel knit fabric.

51. The method according to claim 49, wherein the first fabric is printed using a sublimatic printing process during step (c).

52. The method according to claim 49, wherein the textile layer is printed using a sublimatic printing process after step (c).

53. The method according to claim 52, wherein said printing process results in an observable print resolution of at least 75 dpi.
